(19) United States
(12) Patent Application Publication
(10) Pub. No.: US 2018/0233257 A1
(43) Pub. Date: Aug. 16, 2018

(54) WIRE HARNESS PROTECTION STRUCTURE AND METHOD FOR PRODUCING BRAIDED COVER-EQUIPPED WIRE HARNESS

(71) Applicant: Sumitomo Wiring Systems, Ltd., Yokkaichi (JP)

(72) Inventor: Takeshi YAMAGUCHI, Yokkaichi (JP)

(21) Appl. No.: 15/892,673

(22) Filed: Feb. 9, 2018

(30) Foreign Application Priority Data
Feb. 10, 2017 (JP) 2017-022883

(51) Int. Cl. H01B 13/26; H01B 7/17; D04C 1/06; D04C 3/40

(52) U.S. Cl. CPC H01B 13/2606; H01B 7/17; H01B 7/0045; D04C 3/40; D04C 1/06

(57) ABSTRACT

A novel wire harness protection structure and a method for producing a braided cover-equipped wire harness that can prevent interference between the braided cover and other members without increasing the number of extra steps after braiding. The wire harness protection structure that protects an outer circumferential surface of a wire harness by using a braided cover, including a fold-back portion provided on one end side in an axial direction of the braided cover, the fold-back portion being formed by folding back a terminal end processed portion provided at a braiding start end, inward in a radial direction of the braided cover.

### CROSS REFERENCE TO RELATED APPLICATIONS

This application claims the priority of Japanese patent application JP2017-022883 filed on Feb. 10, 2017, the entire contents of which are incorporated herein.

### TECHNICAL FIELD

The present invention relates to a wire harness protection structure that protects the outer circumferential surface of a wire harness using a braided cover, and a method for producing a braided cover-equipped wire harness.

### BACKGROUND ART

For a wire harness formed by binding a plurality of wiring members such as wires, a braided cover formed by braiding braiding threads has hitherto been used to bind and protect the outer circumferential surface of the wire harness, as described in FIG. 1 of JP 2015-23660A, for example.

Meanwhile, in a braided cover with which the outer circumferential surface of a wire harness is bound and protected, a terminal end processed portion provided at a braiding start end of the braided cover protrudes on the outer circumferential surface on the distal end side of the wire harness, as described in, for example, FIG. 1 of JP 2015-23660A. Such a terminal end processed portion is formed by integrating braiding threads constituting the braided cover by welding them to each other so as not to come loose. Note that in JP 2015-23660A, such a terminal end processed portion is used by catching a hook thereon in order to pull the wire harness upward while forming the braided cover on the outer circumferential surface of the wire harness.

However, with a braided cover that has such a configuration, a hard terminal end processed portion that is formed by welding braiding threads together protrudes on the outer circumferential surface of the wire harness. Accordingly, the terminal end processed portion may come into contact with other members such as a wire harness disposed in close proximity thereto, thus causing damage to other members. Therefore, in order to eliminate the protrusion of the terminal end processed portion, it is conceivable to fix the terminal end processed portion to the outer circumferential surface of the wire harness by wrapping a piece of tape therearound. However, this requires an extra step after braiding, and thus cannot be considered as a desirable countermeasure, and further improvement is required.

JP 2015-23660A is an example of related art.

### SUMMARY

The present design has been made in light of the above-described circumstances, and a problem to be solved by this design is to provide a novel wire harness protection structure and a method for producing a braided cover-equipped wire harness that can prevent interference between the braided cover and other members without increasing the number of extra steps after braiding.

A first aspect of the present design relating to a wire harness protection structure is directed to a wire harness protection structure that protects an outer circumferential surface of a wire harness using a braided cover, including a fold-back portion provided on one end side in an axial direction of the braided cover, the fold-back portion being formed by folding back a terminal end processed portion provided at a braiding start end, inward in a radial direction of the braided cover.

According to this aspect, on at least one end side in the axial direction of the braided cover, the fold-back portion formed by folding back the terminal end processed portion provided at the braiding start end, inward in the radial direction of the braided cover, is provided. This makes it possible to cover the terminal end processed portion of the braided cover with the braided cover from the outer circumferential side, so as not to protrude to the outer surface of the braided cover. Therefore, it is possible to prevent the terminal end processed portion from protruding to the outer circumferential side of the braided cover, thus obviating interference between the braided cover and other members, without increasing the number of extra steps after braiding, such as fixing the terminal end processed portion to the outer circumferential surface of the wire harness by wrapping a piece of tape therearound.

According to a second aspect of the present design relating to a wire harness protection structure, in the wire harness protection structure according to the first aspect, a length dimension in the axial direction of the fold-back portion is 20 to 30 mm.

According to this aspect, since the length dimension in the axial direction of the fold-back portion is 20 to 30 mm, a wrap margin between the outer circumference-side braided portion of the braided cover that is braided on the outer circumferential side and the fold-back portion is sufficiently secured. Therefore, it is possible to reliably prevent the terminal end processed portion from being exposed to the outside of the braided cover.

According to a third aspect of the present design relating to the wire harness protection structure, in the wire harness protection structure according to the first or second aspect, an indicator indicating an area where the fold-back portion is formed is provided on the outer circumferential surface of the wire harness.

According to this aspect, the indicator indicating an area where the fold-back portion is formed is provided on the outer circumferential surface of the wire harness. Therefore, when forming the fold-back portion formed by folding back one end side in the axial direction of the braided cover, inward in the radial direction of the braided cover, the braiding start end that is the starting end of the fold-back portion and the termination end of the fold-back portion can be easily positioned at predetermined positions on the outer circumferential surface of the wire harness.

A first aspect of the present application relating to a method for producing a braided cover-equipped wire harness is directed to a method for producing a braided cover-equipped wire harness to which a braided cover formed by braiding braiding threads on an outer circumferential surface of a wire harness is attached, the method including: a wire harness installation step of inserting the wire harness into a braider from below; a fold-back portion forming step of braiding the braiding threads on the outer circumferential surface of the wire harness while pushing the wire harness downward of the braider, thereby forming a fold-back portion that is braided upward of the braider from a braiding start end; and an outer circumference-side braided portion forming step of, upon completion of the fold-back portion forming step, braiding the braiding threads while pulling the wire harness upward of the braider, thereby forming an outer circumference-side braided portion that is braided on outer circumferential surface of the fold-back portion and beyond the fold-back portion, downward of the braider.

According to this aspect, after the wire harness is installed in the braider in the wire harness installation step, the fold-back portion forming step of performing braiding while pushing the wire harness downward of the braider is performed first, and the fold-back portion that is braided upward from the terminal end processed portion at the braiding start end can be easily formed. By thereafter performing the outer circumference-side braided portion forming step of performing braiding while pulling the wire harness upward, braiding can be performed such that the outer circumference-side braided portion is placed onto the outer circumferential side of the fold-back portion so as to extend downward. Accordingly, a state in which the terminal end processed portion is folded inward in the radial direction on one end side of the braided cover, or in other words, a state in which the fold-back portion that is braided upward from the terminal end processed portion at the braiding start end is covered by the outer circumference-side braided portion provided on the outer circumferential side, can be easily and efficiently achieved with a simple method of simply changing the pulling direction of the wire harness during braiding. Therefore, it is possible to prevent the terminal end processed portion from protruding to the outer circumferential side of the braided cover, thus obviating interference between the braided cover and other members, without increasing the number of extra steps after braiding, such as fixing the terminal end processed portion to the outer circumferential surface of the wire harness by wrapping a piece of tape therearound.

According to a second aspect of the present application relating to the method for producing a braided cover-equipped wire harness, in the method for producing a braided cover-equipped wire harness according to the first aspect, an indicator indicating an area where the fold-back portion is formed is provided on the outer circumferential surface of the wire harness, and the fold-back portion is formed in accordance with the indicator.

According to this aspect, the indicator indicating an area where the fold-back portion is formed is provided on the outer circumferential surface of the wire harness, and the fold-back portion is formed in accordance with the indicator. Accordingly, the fold-back portion can be easily formed at a predetermined position.

According to the present application, the fold-back portion formed by folding back the terminal end processed portion provided at the braiding start end, inward in the radial direction of the braided cover, is provided on one end side in the axial direction of the braided cover. This makes it possible to cover the terminal end processed portion of the braided cover with the braided cover from the outer circumferential side so as not to protrude to the outer surface of the braided cover. Therefore, it is possible to prevent the terminal end processed portion from protruding to the outer circumferential side of the braided cover, thus obviating interference between the braided cover and other members, without increasing the number of extra steps after braiding, such as fixing the terminal end processed portion to the outer circumferential surface of the wire harness by wrapping a piece of tape therearound.

### BRIEF DESCRIPTION OF THE DRAWINGS

FIG. 1 is a front view showing a braided cover-equipped wire harness whose outer circumferential surface is protected with a braided cover by using a wire harness protection structure according to an embodiment of the present application;

FIG. 2 is an enlarged cross-sectional view of relevant portions taken along II-II in FIG. 1;

FIG. 3 is a front view showing a braider that is used to produce a braided cover-equipped wire harness according to the present embodiment; and

FIGS. 4A-4E show front views for illustrating a method for producing a braided cover-equipped wire harness according to the present embodiment, corresponding to FIG. 1, wherein FIG. 4A shows a state before a wire harness installation step, FIG. 4B shows a state after the wire harness installation step, FIG. 4C shows a state after a fold-back portion forming step, FIG. 4D shows a state after an outer circumference-side braided portion forming step, and FIG. 4E shows a state after terminal end processing.

### EMBODIMENTS

Hereinafter, an embodiment of the present application will be described with reference to the drawings.

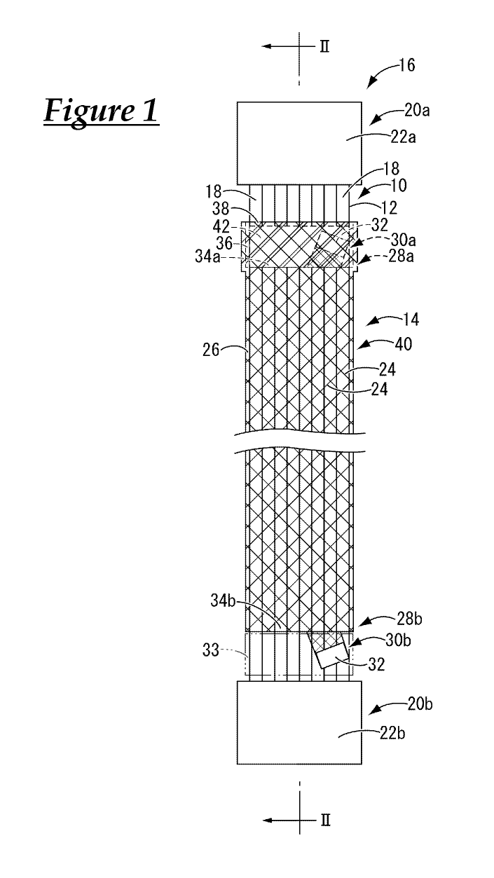

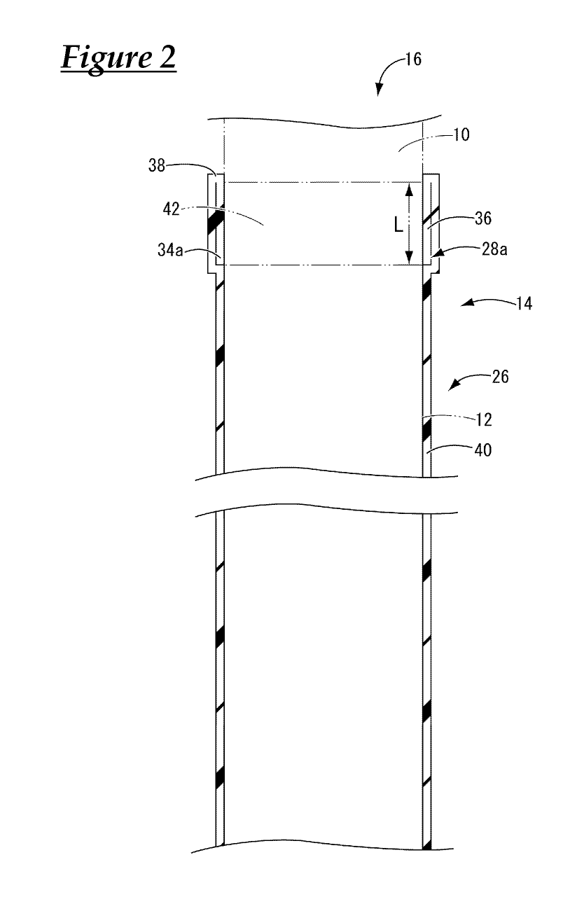

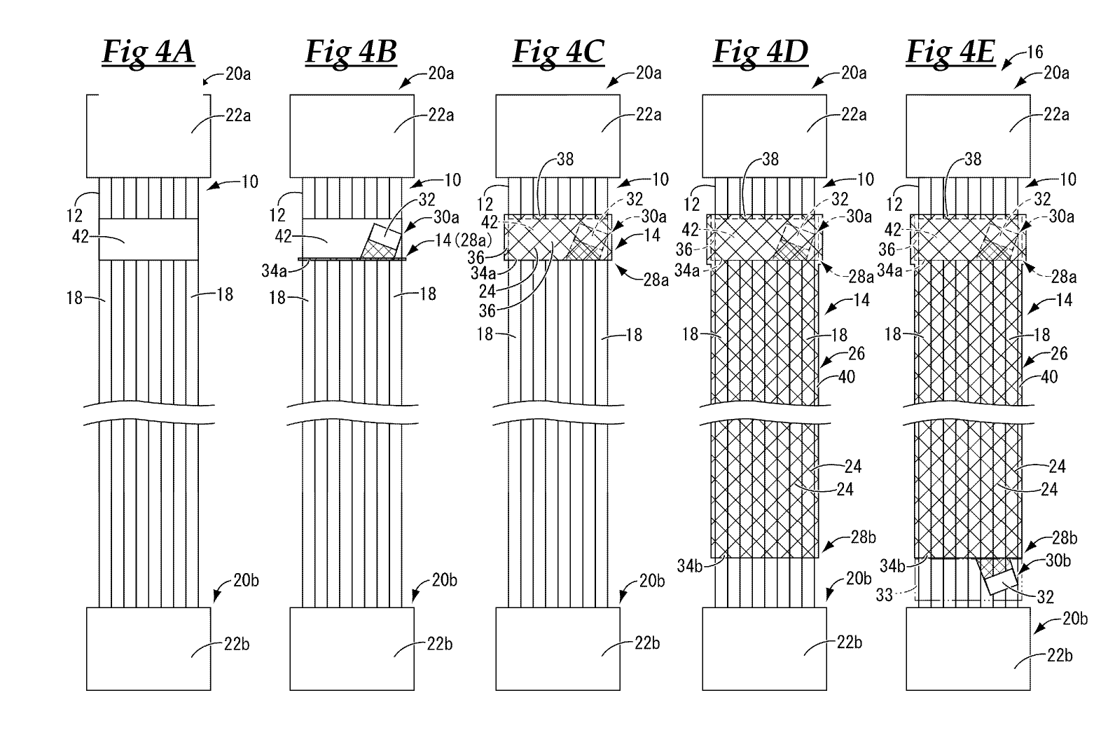

FIGS. 1 to 2 show a braided cover-equipped wire harness 16 that is protected due to an outer circumferential surface 12 of a wire harness 10 being covered with a braided cover 14 using a wire harness protection structure according to an embodiment of the present application. Note that in the following description, “upward” refers to upward in FIGS. 1 to 2, “downward” refers to downward in FIGS. 1 to 2. In addition, “axial direction” refers to the up-down direction in FIGS. 1 to 2, and “radial direction” refers to the left-light direction in FIGS. 1 to 2. To facilitate understanding, a piece of binding tape 33, which will be described later, in FIG. 1 (FIG. 4(e)), and, in FIG. 2, the wire harness 10 and a piece of tape 42 serving as an indicator indicating where a fold-back portion 36, which will be described later, is formed are indicated by virtual lines.

The wire harness 10 is configured by bundling a plurality of (eight in the present embodiment) wires 18 that are wiring members, and connectors 20a and 20b are provided at opposite terminal ends thereof. Connector housings 22a and 22b constituting the connectors 20a and 20b are both substantially block-shaped, and are integrally formed through injection molding or the like using, for example, a synthetic resin such as polypropylene (PP) or polyamide (PA). A plurality of cavities (not shown) are formed so as to extend through the inside of the connector housings 22a and 22b in the axial direction of the wire harness 10, and connector terminals (not shown) provided at the opposite terminal ends of the plurality of wires 18 are each configured to be inserted into the plurality of cavities, and be disposed at predetermined positions in the plurality of cavities. Then, the connectors 20a and 20b are fitted to mating connectors (not shown), thus electrically connecting the wire harness 10 to a wire harness (not shown) extending from each of the mating connectors.

As shown in FIGS. 1 to 2, the outer circumferential surface 12 of the bundle of plurality of wires 18 constituting the thus formed wire harness 10 is protected due to being covered with the braided cover 14, thus forming the braided cover-equipped wire harness 16. More specifically, the braided cover 14 includes a tubular portion 26 that is formed in a tubular shape by braiding braiding threads 24 made of a plurality of synthetic fiber threads, metal threads, or the like into a mesh-like member so as to come into close contact with the outer circumferential surface 12. The braided cover 14 can slightly extend in the radial direction and the axial direction due to the pliability of the synthetic fiber threads, metal threads, or the like. For example, a polyamide fiber with a certain degree of abrasion resistance, oil resistance, flexibility, and the like can be used as a synthetic fiber thread. On the other hand, any metal material that has electrical conductivity can be used as a metal thread, and it is preferable to use light-weight aluminum, an alloy thereof, or the like.

As shown in FIG. 1, terminal end processed portions 30a and 30b are formed on one end side 28a in the axial direction (the upper end side in FIG. 1), and the other end side 28b in the axial direction (the lower end side in FIG. 1), respectively, of the tubular portion 26 of the braided cover 14. The terminal end processed portions 30a and 30b are subjected to terminal end processing in which the tubular portion 26 consisting of the braiding threads 24 formed by braiding the plurality of synthetic fiber threads, metal threads, or the like into a mesh-like member is welded on the one end side 28a in the axial direction and the other end side 28b in the axial direction of the braided cover 14 so as to gather the braiding threads 24 together, and, as needed, a piece of binding tape 32 is wound around the welded portions so as to cover the welded portions. Note that the terminal end processed portions 30a and 30b are formed so as to respectively protrude from the one end side 28a in the axial direction and the other end side 28b in the axial direction toward the connector 20a and the connector 20b. On the other hand, the terminal end processed portion 30b is fixed to the outer circumferential surface 12 of the wire harness 10 by wrapping a piece of binding tape 33 therearound. In the present embodiment, the one end side 28a in the axial direction of the tubular portion 26 of the braided cover 14 is set as a braiding start end 34a, whereas the other end side 28b in the axial direction of the tubular portion 26 of the braided cover 14 is set as a braiding finish end 34b.

As shown in FIGS. 1 and 2, on the one end side 28a in the axial direction of the braided cover 14, a fold-back portion 36 is formed by folding back (see FIG. 2) the braiding start end 34a of the tubular portion 26, inward in the radial direction (the left-right direction in FIG. 1) of the braided cover 14 and downward, while leaving the terminal end processed portion 30a as it is (so as to protrude obliquely upward in FIG. 1). In this manner, the fold-back portion 36 is formed on the one end side 28a in the axial direction of the braided cover 14 by folding back the braiding start end 34a of the tubular portion 26 of the braiding thread 24, inward in the radial direction of the braided cover 14, together with the terminal end processed portion 30a provided at the braiding start end 34a. Then, a portion extending from an upper end portion 38 of the fold-back portion 36 to the braiding finish end 34b on the lower end side (the lower side in FIGS. 1 to 2) of the wire harness 10 constitutes an outer circumference-side braided portion 40. The outer circumference-side braided portion 40 is configured to be placed onto the outer circumferential surface of the fold-back portion 36, and to extend further downward thereof so as to come into close contact with the outer circumferential surface 12 of the bundle of wires 18 constituting the wire harness 10.

In the present embodiment, the length dimension: L (see FIG. 2) of the fold-back portion 36 in the axial direction is 20 to 30 mm. Accordingly, a wrap margin between the fold-back portion 36 and the outer circumference-side braided portion 40 placed onto the outer circumferential surface of the fold-back portion 36 can be sufficiently secured. Therefore, the terminal end processed portion 30a provided at the braiding start end 34a can be covered by the fold-back portion 36 and the outer circumference-side braided portion 40 of the braided cover 14, making it possible to reliably prevent the terminal end processed portion 30a from being exposed to the outside of the braided cover 14. Moreover, as shown in FIGS. 1 and 2, a piece of tape 42 serving as an indicator indicating an area where the fold-back portion 36 is formed is wrapped around the outer circumferential surface 12 of the bundle of wires 18 constituting the wire harness 10. Accordingly, when forming the fold-back portion 36 by folding back the one end side 28a in the axial direction of the braided cover 14, inward in the radial direction of the braided cover 14, the braiding start end 34a that is the starting end of the fold-back portion 36 and the upper end portion 38 (see FIG. 2) that is the termination of the fold-back portion 36 can be easily positioned at predetermined positions on the outer circumferential surface 12 of the bundle of wires 18 constituting the wire harness 10.

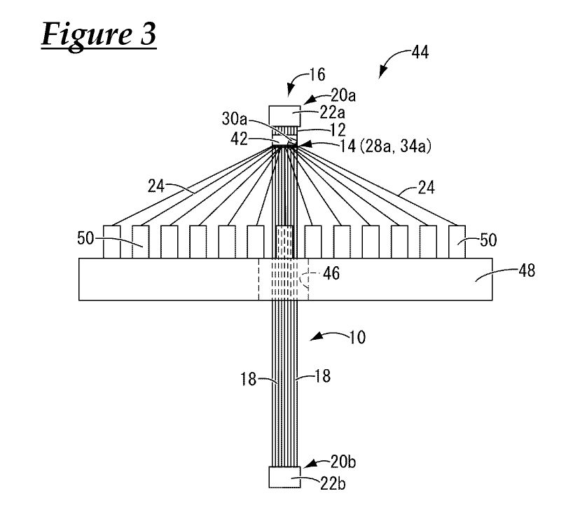

Next, an embodiment of the present application relating to a method for producing a braided cover-equipped wire harness that can be suitably used to produce such a braided cover-equipped wire harness 16 will be described with reference to FIGS. 3 and 4.

First, the wire harness 10 shown in FIG. 4A is prepared. As previously described, the piece of tape 42 serving as an indicator indicating an area where the fold-back portion 36 is formed is wrapped around the outer circumferential surface 12 of the bundle of wires 18 constituting the wire harness 10. Subsequently, as shown in FIG. 3, a wire harness installation step of inserting the wire harness 10 into a braider 44 from below is performed. More specifically, the braider 44 includes a disk-shaped base plate 48 with, at a central portion thereof, a cross-sectionally substantially circular wire harness insertion hole 46 extending therethrough in the plate thickness direction (the up-down direction in FIG. 3), and a plurality of bobbins 50 provided on the base plate 48, from which the braiding threads 24 made of metal threads, synthetic fiber threads, or the like are supplied to a point at which a braid is to be formed. A plurality of braiding threads 24 are rotated in an intertwining manner around the outer circumferential surface 12 of the bundle of wires 18 constituting the wire harness 10, thus braiding a braided cover 14 in the form of a braid. Note that a known device that forms a braid around a core such as a mandrel, for example, can be used as the braider 44. Then, as shown in FIGS. 3 and 4, the braiding threads 24 are collected from the plurality of bobbins 50 and welded together, and a piece of binding tape 32 is wound around a distal end portion thereof, thereby forming the terminal end processed portion 30a. Subsequently, the wire harness 10 is inserted into the braider 44 through the wire harness insertion hole 46 from below, and the connector housing 22a included in the wire harness 10 is made to protrude upward through the gap between the braiding threads 24 extending from the plurality of bobbins 50 connected to the terminal end processed portion 30a. Then, a proximal end portion of the terminal end processed portion 30a is disposed at a lower end portion of the piece of tape 42 indicating the area where the fold-back portion 36 is formed, and thus, the braiding start end 34a around which the braiding threads 24 extending from the bobbins 50 are wound can be easily positioned at the lower end portion of the piece of tape 42, which is the predetermined position (see FIGS. 3 and 4B). This completes the wire harness installation step.

Next, an upper end portion of the wire harness 10 that has been positioned inside the braider 44 in this manner is held, and the braider 44 is operated to perform braiding, while pushing the wire harness 10 downward of the braider 44, and thus, braiding can be performed on the outer circumferential surface 12 of the wire harness 10 from the braiding start end 34a upward of the braider 44. By performing such braiding in accordance with the tape 42 indicating the area where the fold-back portion 36 is formed, or in other words, to the upper end portion of the tape 42, the fold-back portion 36 can be formed at the predetermined position of the outer circumferential surface 12 of the wire harness 10, i.e., the piece of tape 42 (see FIG. 4C). In this manner, a fold-back portion forming step of forming the fold-back portion 36 that is braided from the braiding start end 34a upward of the braider 44 is performed.

Subsequently, upon completion of the fold-back portion forming step, the wire harness 10 is pulled upward of the braider 44 while the braiding operation continues, and as a result, braiding can be performed from the upper end portion 38 that is the braiding finish end of the fold-back portion 36, on the outer circumferential surface of the fold-back portion 36 and beyond the fold-back portion 36, downward of the braider 44. By performing such braiding, an outer circumference-side braided portion 40 extending over the outer circumferential surface of the fold-back portion 36 and the outer circumferential surface 12 of the wire harness 10 beyond the fold-back portion 36 can be formed (see FIG. 4D). In this manner, an outer circumference-side braided portion forming step of forming the outer circumference-side braided portion 40 that is braided downward of the braider 44 from the upper end portion 38 that is the braiding finish end of the fold-back portion 36 to the braiding finish end 34b on the other end side 28b in the axial direction is performed.

Finally, as shown in FIG. 4E, after the outer circumference-side braided portion forming step, the tubular portion 26 of the braided cover 14 is welded at the braiding finish end 34b on the other end side 28b in the axial direction so as to gather the braiding threads 24 together, and a piece of binding tape 32 is wrapped therearound, thus forming the terminal end processed portion 30b. Then, the terminal end processed portion 30b is fixed to the outer circumferential surface 12 of the wire harness 10 by wrapping a piece of binding tape 33 therearound. Alternatively, the terminal end processed portion 30b may be folded back and housed inside the tubular portion 26. As a result of the foregoing, the braided cover-equipped wire harness 16 to which the braided cover 14 formed by braiding the braiding threads 24 on the outer circumferential surface 12 of the wire harness 10 is attached can be obtained.

With the braided cover-equipped wire harness 16 obtained using such a production method, on one end side 28a in the axial direction of the braided cover 14, the braiding start end 34a of the tubular portion 26 constituted by the braiding threads 24 is folded back, inward in the radial direction of the braided cover 14, together with the terminal end processed portion 30a provided at the braiding start end 34a, thus forming the fold-back portion 36. Accordingly, the terminal end processed portion 30a formed on the one end side 28a in the axial direction of the braided cover 14 can be covered by the braided cover 14 from the outer circumferential side so as not to protrude to the outer surface of the braided cover 14. Therefore, it is possible to prevent the terminal end processed portion 30a from protruding to the outer circumferential side of the braided cover 14, thus obviating interference between the braided cover 14 and other members (not shown), without increasing the number of extra steps after braiding, such as fixing the terminal end processed portion 30a to the outer circumferential surface 12 of the wire harness 10 by wrapping a piece of tape therearound.

In addition, with the production method of the present embodiment, after installing the wire harness 10 in the braider 44 in the wire harness installation step, the fold-back portion forming step of performing braiding while pushing the braider 44 downward of the wire harness 10 is performed first, and as a result, a fold-back portion 36 that has been subjected to braiding upward from the braiding start end 34a can be easily formed. Furthermore, the outer circumference-side braided portion forming step of performing braiding while pulling the wire harness 10 upward of the braider 44 is subsequently performed, and thus, braiding can be performed on the outer circumferential surface of the fold-back portion 36 and beyond the fold-back portion 36, downward of the braider 44. Therefore, the terminal end processed portion 30a formed on the one end side 28a in the axial direction of the braided cover 14 can be covered by the braided cover 14 from the outer circumferential side so as not to protrude to the outer surface of the braided cover 14 easily and efficiently by using a simple method of simply changing the pulling direction of the wire harness 10 during braiding from downward to upward.

Although an embodiment has been described above in detail, the invention is not intended to be limited by the specific description thereof. For example, with the braided cover-equipped wire harness 16 and the production method thereof in the above embodiment, the terminal end processed portion 30a formed on one end side 28a in the axial direction of the braided cover 14 is welded, and the binding tape 32 is wound therearound. However, the terminal end processed portion 30a is covered by the braided cover 14 from the outer circumferential side so as not to protrude to the outer surface of the braided cover 14 in the present embodiment, and therefore, may be fixed in a simple manner using only the binding tape 32, without being welded. In the present embodiment, a piece of tape 42 is adopted as the indicator indicating the area where the fold-back portion 36 is formed. However, any means such as wrapping cloth or applying ink may be adopted.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

10 Wire harness
12 Outer circumferential surface
14 Braided cover
16 Braided cover-equipped wire harness
24 Braiding thread
28a One end side
30a, 30b Terminal end processed portion
34a Braiding start end
36 Fold-back portion
40 Outer circumference-side braided portion
42 Tape (indicator)
44 Braider

What is claimed is:

1. A wire harness protection structure that protects an outer circumferential surface of a wire harness using a braided cover, comprising
a fold-back portion provided on one end side in an axial direction of the braided cover, the fold-back portion being formed by folding back a terminal end processed portion provided at a braiding start end, inward in a radial direction of the braided cover.

2. The wire harness protection structure according to claim 1, wherein
a length dimension in the axial direction of the fold-back portion is 20 to 30 mm.

3. The wire harness protection structure according to claim 1, wherein
an indicator indicating an area where the fold-back portion is formed is provided on the outer circumferential surface of the wire harness.

4. A method for producing a braided cover-equipped wire harness to which a braided cover formed by braiding braiding threads on an outer circumferential surface of a wire harness is attached, the method comprising:
a wire harness installation step of inserting the wire harness into a braider from below;
a fold-back portion forming step of braiding the braiding threads on the outer circumferential surface of the wire harness while pushing the wire harness downward of the braider, thereby forming a fold-back portion that is braided upward of the braider from a braiding start end; and
an outer circumference-side braided portion forming step of, upon completion of the fold-back portion forming step, braiding the braiding threads while pulling the wire harness upward of the braider, thereby forming an outer circumference-side braided portion that is braided on an outer circumferential surface of the fold-back portion and beyond the fold-back portion, downward of the braider.

5. The method for producing a braided cover-equipped wire harness according to claim 4, wherein
an indicator indicating an area where the fold-back portion is formed is provided on the outer circumferential surface of the wire harness, and the fold-back portion is formed in accordance with the indicator.
